(19) United States
(12) Patent Application Publication
(10) Pub. No.: US 2009/0033774 A1
(43) Pub. Date: Feb. 5, 2009

(54) Imaging device

(75) Inventors: Kenji Ohishi, Kawasaki-shi (JP); Kenji Suzuki, Kawasaki-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/219,918

(22) Filed: Jul. 30, 2008

(30) Foreign Application Priority Data
Jul. 31, 2007 (JP) 2007-198493
Oct. 18, 2007 (JP) 2007-270823

(51) Int. Cl. H04N 5/217

(52) U.S. Cl. 348/241; 348/E05.078

(57) ABSTRACT

An imaging device includes an image pickup sensor that picks up subject light to output image pickup signals, the image pickup sensor having a boundary region generated due to the use of a divided exposure process in the manufacture of the image pickup sensor. In the imaging device, a display unit displays a through image based on image data produced from the image pickup signals, and a selection unit selects a magnification of the through image to be displayed on the display unit. Further, a correction unit performs a correction process on signal differences generated in the image data due to the boundary region of the image pickup sensor, and a control unit controls the correction unit to selectively perform the correction process based on the magnification selected by the selection unit.

### INCORPORATION BY REFERENCE

The disclosure of the following priority application is herein incorporated by reference: Japanese Patent Application No. 2007-198493 filed Jul. 31, 2007, and Japanese Patent Application No. 2007-270823 filed Oct. 18, 2007.

### FIELD OF THE INVENTION

The present invention relates to an imaging device that performs display of a through image based on image data produced from image signals.

### BACKGROUND OF THE INVENTION

Recently, a large size image pickup sensor (having an increased image pickup area) such as a 35 mm full-size image pickup sensor or the like is mounted to a digital single-lens reflex camera. A photolithography process is included in the process of manufacturing the image pickup sensor. Seeing that an exposure area exposable at one time is limited in an exposure apparatus (a stepper or the like) used in the photolithography process, a divided exposure is performed if necessary. The divided exposure means that, when at least one of a semiconductor layer, a color filter layer and a micro lens layer is formed in the manufacture of a large size image pickup sensor, an exposure area of a substrate to be exposed is dividedly exposed in different exposure processes (see, e.g., Japanese Patent Laid-open Publication No. 2006-73624). In the image data originating from image signals outputted from the large size image pickup sensor thus manufactured, there may sometimes exist signal differences (or signal variations) attributable to the presence of boundary portions (or boundary regions) generated due to the use of a divided exposure process in the manufacture of the image pickup sensor.

It is also often the case that, due to the manufacturing process, signal variations are generated in the edge region of an image. In certain cases, the image pickup sensor may have defective pixels. Signal variations may also be generated in those regions where the defective pixels exist.

In case of taking a still image, signal differences (or signal variations) generated in the image data due to the boundary regions of the image pickup sensor are corrected by a signal processing unit so that they can become invisible on the still image. Signal variations attributable to the presence of an edge region or a defective pixel region are also corrected in a similar manner. However, if such correction is attempted to perform when displaying a through image, it is sometimes the case that the load borne by the signal processing unit may be increased, which may pose a problem of heat generation or other problems.

### SUMMARY OF THE INVENTION

Therefore, the present invention provides an imaging device by which, in case of displaying a through image, correction of signal differences or signal variations generated in image data is selectively carried out under a specified condition.

In accordance with a first aspect of the present invention, there is provided an imaging device including: an image pickup sensor that images a subject to output image pickup signals, the image pickup sensor having a boundary portion generated due to a divided exposure process carried out during the manufacture thereof; a display unit that displays a through image based on image data produced from the image pickup signals; a selection unit that selects a magnification of the through image to be displayed on the display unit; a correction unit that performs a correction process on signal differences generated in the image data due to the boundary portion of the image pickup sensor; and a control unit that controls the correction unit to selectively perform the correction process based on the magnification selected by the selection unit.

In accordance with a second aspect of the present invention, there is provided an imaging device including: an image pickup sensor that images a subject to output image pickup signals, the image pickup sensor having a boundary portion generated due to a divided exposure process carried out during the manufacture thereof; a display unit that displays a through image based on image data produced from the image pickup signals, which are thinned with an arbitrary thinning ratio; a correction unit that performs a correction process on signal differences generated in the image data due to the boundary portion of the image pickup sensor; and a control unit that controls the correction unit to selectively perform the correction process based on the thinning ratio.

In accordance with a third aspect of the present invention, there is provided an imaging device including: an image pickup sensor that images a subject to output image pickup signals; a display unit that displays a through image based on image data produced from the image pickup signals; a selection unit that selects a magnified displaying area of the through image to be displayed on an enlarged scale on the display unit; a determination unit that determines whether the magnified displaying area selected by the selection unit contains a specific region; and a correction unit that performs a correction process on signal variations generated in the image data, if the determination unit determines that the magnified displaying area contains the specific region and if an instruction is issued to perform magnified displaying.

With the present imaging device, in case of displaying the through image, correction of the signal differences or signal variations generated in the image data is selectively carried out depending on the magnification of the through image, the thinning ratio of the image signals when displaying the through image, or the magnified displaying area of the through image. Thanks to this feature, it is possible to perform correction of the signal differences or signal variations generated in the image data, only when such a need arises. It is also possible to prevent an increase in the load borne by the image correction unit or the like, which would otherwise be caused by the correction of the signal differences or signal variations. This makes it possible to display the through image in a good quality for an extended period of time.

### BRIEF DESCRIPTION OF THE DRAWINGS

The objects and features of the present invention will become apparent from the following description of embodiments, given in conjunction with the accompanying drawings, in which:

FIG. 1 is a block diagram of a digital camera in accordance with a first embodiment of the present invention;

FIG. 2 is a flow chart for explaining an operation of the digital camera in accordance with the first embodiment of the present invention;

FIG. 3 shows an color filter array arranged on individual pixels of an image pickup sensor in the first embodiment and a second embodiment of the present invention;

FIG. 4A is a view illustrating one example of a through image (displayed on a non-enlarged scale) in the first embodiment of the present invention and FIG. 4B is a view enlargedly showing a part of the through image illustrated in FIG. 4A;

FIG. 5 is a view for explaining stitching correction in the first and second embodiments of the present invention;

FIG. 6 is a block diagram of a digital camera in accordance with the second embodiment of the present invention;

FIG. 7 is a view for explaining the regions for which signal variations are corrected according to the second embodiment of the present invention;

FIG. 8 is a flow chart for explaining an operation of the digital camera in accordance with the second embodiment of the present invention; and

FIG. 9 is a view showing a state that magnified displaying areas of a through image are selected in the second embodiment of the present invention.

### DETAILED DESCRIPTION OF THE EMBODIMENTS

### First Embodiment

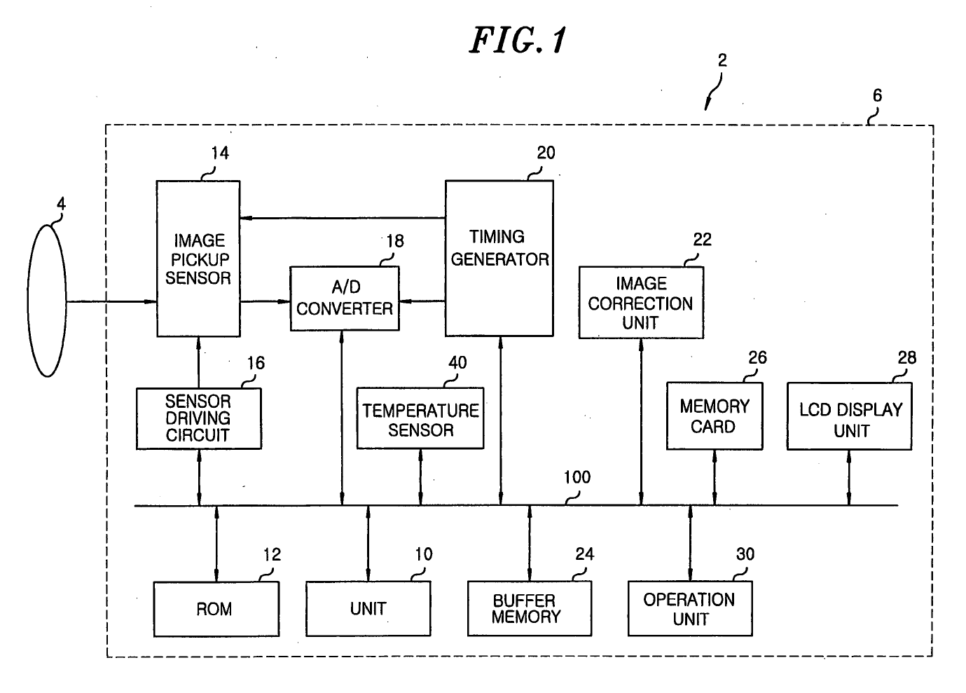

Hereinafter, an imaging device in accordance with a first embodiment of the present invention will be described with reference to accompanying drawings which form a part hereof. FIG. 1 is a block diagram of a digital camera in accordance with the first embodiment of the present invention. As shown in FIG. 1, a digital camera (imaging device) 2 includes a photographic lens 4 and a camera body 6. In this regard, the photographic lens 4 may be either a lens fixedly secured to the camera body 6 or a replaceable photographic lens.

The camera body 6 is provided with a CPU 10 which in turn is connected to a system bus 100. Responsive to the signals inputted from individual blocks which will be described later, the CPU 10 performs specified calculation using a control program stored in a ROM 12 connected to the system bus 100 and then outputs control signals to the respective blocks based on the results of calculation.

An image pickup sensor 14 formed of a CCD, a CMOS or the like is connected to the system bus 100 through a sensor driving circuit 16. Also connected to the system bus 100 are an A/D converter 18, a timing generator 20, an image correction unit 22, a buffer memory 24, a memory card 26, an LCD display unit 28 and an operation unit 30.

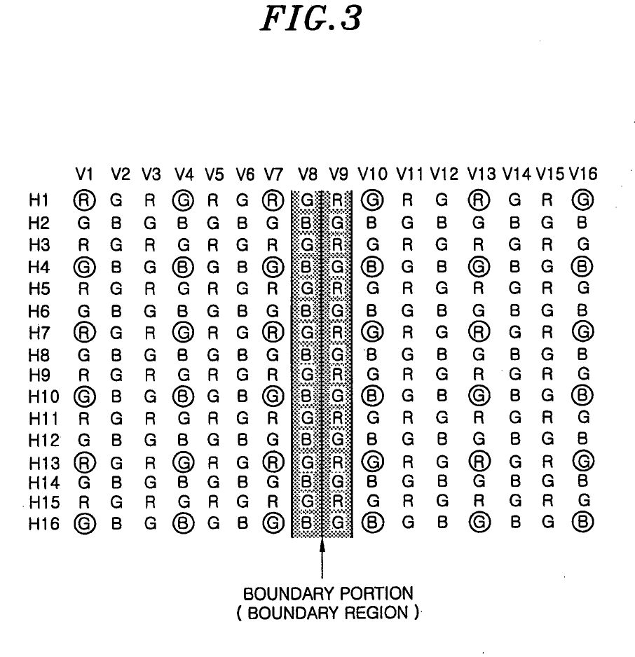

The image pickup sensor 14 picks up subject light coming through the photographic lens 4 and outputs image pickup signals (analog signals as accumulated charges). The image pickup sensor 14 is a 35 mm full-size image sensor (having a size of 24 mm×36 mm) and has a boundary portion generated due to the use of a divided exposure process in the manufacture thereof (see FIG. 3). The image pickup signals outputted from the image pickup sensor 14 are converted to digital signals in the A/D converter 18 and then sent to the image correction unit 22 via the system bus 100. The timing generator 20 outputs a timing signal for driving the image pickup sensor 14 and a timing signal for driving the A/D converter 18.

With respect to the image data originating from the image pickup signals outputted from the image pickup sensor 14, the image correction unit 22 performs image processing such as white balance adjustment, contour compensation and gamma correction, compression processing of the image data, decompression processing of the compressed image data, and so forth. In case of displaying a through image on the LCD display unit 28 based on the image data, the image correction unit 22 performs correction of signal differences or signal variations appearing in the image data under the influence of the boundary portion generated due to the use of a divided exposure process in the manufacture of the image pickup sensor 14. In other words, during the manufacture of the image pickup sensor 14, the surface thereof is divided into a plurality of regions, each of which is exposed in different exposure processes. For that reason, it is sometimes the case that there occurs a difference in the output intensity of the image pickup signals on a region-by-region basis. Therefore, the image correction unit 22 performs correction of the signal differences or signal variations attributable to the difference in the output intensity of the image pickup signals.

The buffer memory 24 refers to a memory that temporarily stores original image data or corrected image data. The memory card 26 is formed of a flash memory or the like and is designed to record compressed image data (of still images or moving images).

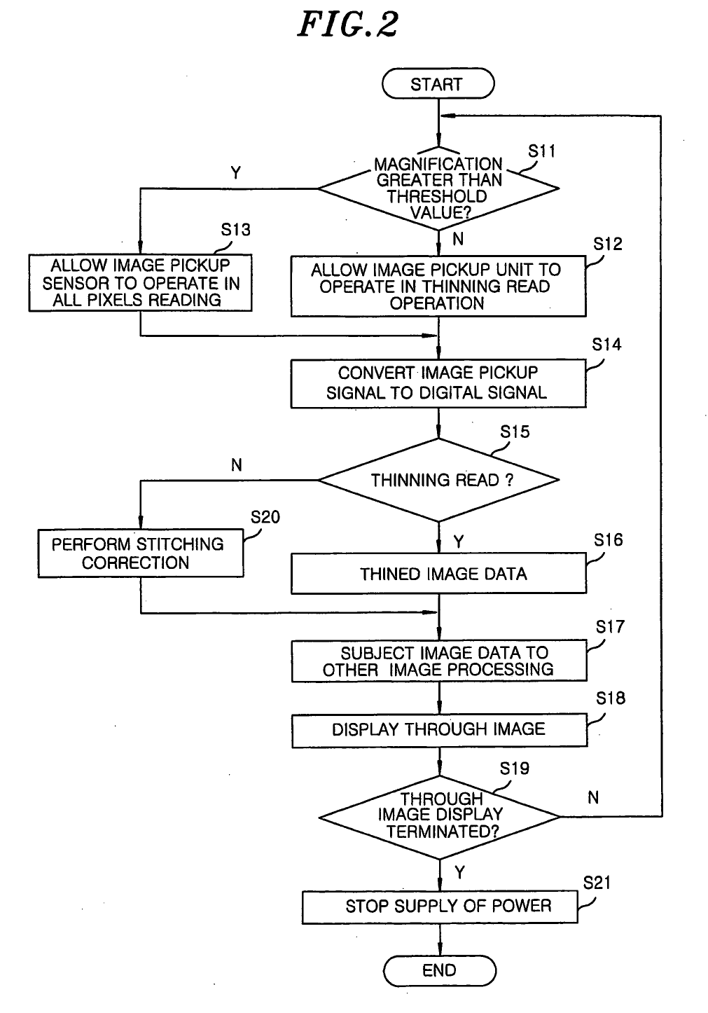

Next, an operation of the digital camera 2 in accordance with the first embodiment of the present invention will be described with reference to the flow chart illustrated in FIG. 2. First, a power button (not shown) of the operation unit 30 is operated to turn on a power supply of the digital camera 2. Then, if a through-image display mode is selected by operating a selection button (not shown) of the operation unit 30, the processing for displaying the through image is started. Specifically, determination is first made as to whether a magnification of the through image displayed exceeds a threshold value (step S11). The magnification of the through image is set equal to 1 at the time when the power supply of the digital camera 2 is turned on. Therefore, the determination made in step S11 answers “N” and the flow proceeds to step S12 where the image pickup sensor 14 is allowed to operate in a thinning read mode (step S12).

FIG. 3 shows a state that color filters of red (R), green (G) and blue (B) colors are arranged on individual pixels of the image pickup sensor 14 according to the Bayer color filter array. In case the thinning ratio is 2/3 when the image pickup sensor 14 is operated in the thinning read mode, the pixels corresponding to the image data used in displaying the through image are indicated by circles in FIG. 3. The thinning ratio refers to the ratio of the number of thinned pixels to the total number of pixels of the image pickup sensor 14. If the thinning ratio is 2/3, two thirds of rows and columns are thinned at regular intervals so that 1/9 of the total pixels are used in displaying the through image. Since the color filters are arranged on the individual pixels according to the Bayer color filter array, the thinning ratio used in the present embodiment includes 2/3, 4/5 and the like.

In this connection, the thinning ratio is preset to 2/3 in case the magnification of the through image is set equal to 1. Therefore, the image pickup signals corresponding to the pixels in the rows of H1, H4, H7, H10, H13 and H16 shown in FIG. 3 are read out from the image pickup sensor 14 under the control of the sensor driving circuit 16 (step S12). The image pickup signals thus read are outputted to the A/D converter 18 and converted to digital signals (step S14).

The image pickup signals converted to digital signals in the A/D converter 18 are sent to the image correction unit 22. Since the image pickup signals have been read out from the image pickup sensor 14 by the thinning read operation (“Y” in step 15), the image correction unit 22 performs signal thinning processing by which the image pickup signals converted to digital signals are thinned in a predetermined thinning ratio (step S16). In other words, since the thinning ratio has been set to 2/3, the image pickup signals corresponding to the pixels in the columns of V2, V3, V5, V6, V8, V9, V11, V12, V14 and V15 are thinned to produce image data with a thinning ratio of 2/3.

In this case, the image data corresponding to the pixels in the columns of V8 and V9 adjacent to the boundary portion of the image pickup sensor 14 are not included in the image data. For that reason, there is no need to perform the stitching correction (or signal difference correction) which will be set forth later. As noted above, when carrying out the thinning read operation, the reading operation is controlled in such a manner as not to read out the image pickup signals corresponding to the pixels (pixel columns) adjacent to the boundary portion. This makes it possible to omit the stitching correction processing. It is already known through design values in which part of the image pickup sensor 14 the boundary portion exists (namely, which pixels lie adjacent to the boundary portion). Therefore, when performing the thinning read operation, the pixels to be thinned are decided using the information on the design values (position information on pixels lying adjacent to the boundary portion) The image data thus generated are subjected to image processing such as white balance adjustment, contour compensation, gamma correction or the like (step S17) and then sent to the LCD display unit 28 so that a through image can be displayed on the LCD display unit 28 (step S18).

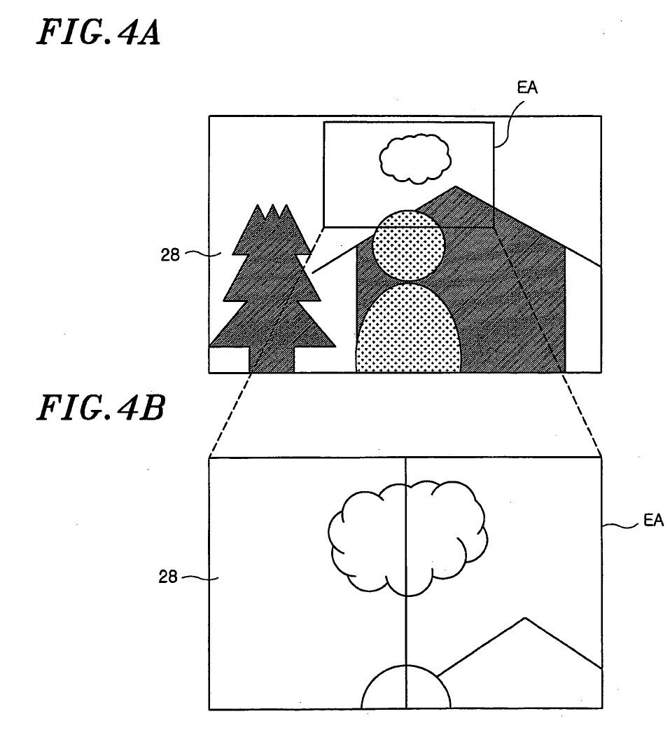

If the magnification of the through image is changed by operating a selection button (not shown) of the operation unit 30 while the through image is displayed on the LCD display unit 28 (“N” in step S19), determination is made as to whether the magnification exceeds the threshold value (step S11). FIG. 4A is a view illustrating one example of the through image displayed on the LCD display unit 28 and FIG. 4B is a view enlargedly depicting the area EA of the through image illustrated in FIG. 4A.

If the magnification of the through image is equal to or greater than the threshold value, e.g., 4, as illustrated in FIGS. 4A and 4B, the determination made in step S11 answers “Y” and the flow proceeds to step S13, thereby operating the image pickup sensor 14 in an all pixels reading mode (step S13). In other words, the image pickup signals corresponding to the entire pixels in the rows of H1 to H16 shown in FIG. 3 are read out from the image pickup sensor 14 under the control of the sensor driving circuit 16 and then outputted to the A/D converter 18 in which the image pickup signals are converted to digital signals (step S14).

The image pickup signals converted to digital signals in the A/D converter 18 are sent to the image correction unit 22. Since it is determined in step S15 that the image pickup signals are read out from the image pickup sensor 14 in the all pixels reading mode, stitching correction (signal difference correction) is carried out (step S20). In other words, the boundary portion generated due to the use of a divided exposure process in the manufacture of the image pickup sensor 14 exists between the pixels in column V8 and the pixels in column V9 as shown in FIG. 3. Thus, it is often the case that signal differences are generated in the image data corresponding to the pixels in columns V8 and V9. Therefore, the stitching correction is performed to eliminate these signal differences, thereby producing image data for use in displaying the through image.

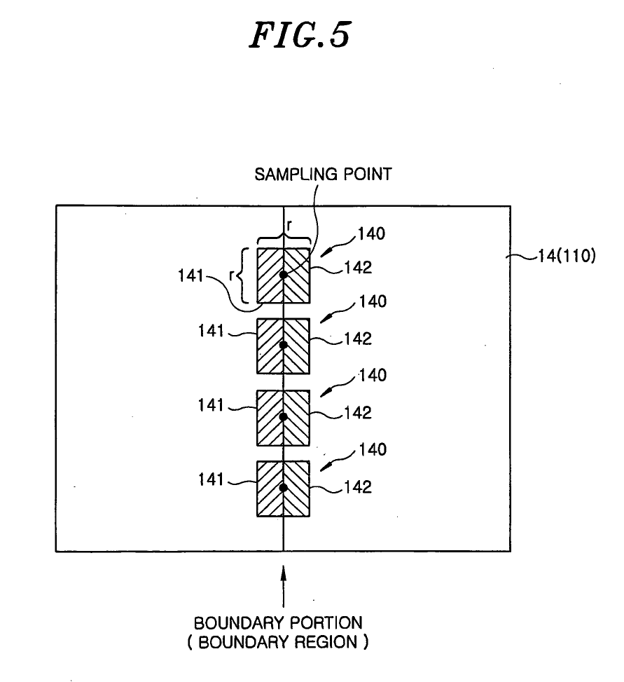

Now, description will be made on the stitching correction processing (signal difference correction processing). In case of performing the stitching correction, sampling points are first set at a specified interval along the boundary portion of the image pickup sensor 14 as illustrated in FIG. 5. Local areas 140 each containing r pixels in horizontal and vertical directions (where “r” stands for a specified natural number) are defined around the respective sampling points. Each of the local areas 140 is divided into a left area 141 and a right area 142 with respect to the boundary portion of the image pickup sensor 14. Left average values of individual output components of R, Gr, Gb and B are found in the left area 141 and right average values of the individual output components of R, Gr, Gb and B are found in the right area 142. In this regard, Gr is an output component of G pixels present in an R pixel row (a row in which R pixels exist) and Gb is an output component of G pixels present in a B pixel row (a row in which B pixels exist)

Next, with respect to each sampling point, the ratio of the left and the right signal differences is calculated. The ratio of the left and the right signal differences is referred to as a stitching correction coefficient. The stitching correction coefficients of the R, Gr, Gb and B components are calculated as follows:

Stitching correction coefficient of R component=(left average value of R component)/(right average value of R component);

Stitching correction coefficient of Gr component=(left average value of Gr component)/(right average value of Gr component);

Stitching correction coefficient of Gb component=(left average value of Gb component)/(right average value of Gb component); and

Stitching correction coefficient of B component=(left average value of B component)/(right average value of B component).

Since it is assumed herein that the right side of the boundary portion is corrected, the stitching correction coefficients are found by taking the corresponding left average values as a numerator and the corresponding right average values as a denominator.

Slope changes for rendering the stitching correction coefficients calculated with respect to the respective sampling points convergent to 1 over a specified width perpendicular to the boundary portion are created for the respective sampling points. Slope correction data are produced by supplementing (e.g., weight-averaging) the slope changes in a direction in which the boundary portion extends. Then, the R, Gr, Gb and B output components of the pixels present in a specified width on the right side of the boundary portion are respectively multiplied by the slope correction data, thereby correcting the signal variations of the image data. The stitching correction (signal difference correction) processing is performed in the above-noted manner.

After the signal differences of the image data have been corrected, the image data are subjected to image processing such as white balance adjustment, contour compensation, gamma correction or the like (step S17) and then sent to the LCD display unit 28 so that the through image can be displayed on the LCD display unit 28 (step S18).

In case the termination of display of the through image is instructed by operating a selection button (not shown) of the operation unit 30 (step S19), the supply of power to the image pickup sensor 14 is stopped, thereby terminating the display of the through image (step S21).

With the imaging device of the first embodiment described above, in case of displaying the through image, correction of the signal differences generated in the image data by the boundary portion of the image pickup sensor is selectively carried out depending on the magnification of the through image or the thinning ratio of the image signals when displaying the through image. Thanks to this feature, it is possible to perform correction of the signal differences generated in the image data, only when such a need arises. It is also possible to prevent an increase in the load borne by the image correction unit or the like, which would otherwise be caused by the correction of the signal differences. This makes it possible to reduce power consumption.

In the first embodiment described above, thinning readoperation of the image data is performed with a thinning ratio of 2/3 (in which case no stitching correction is carried out) if the magnification of the through image being displayed is equal to 1 through 4. If the magnification of the through image is greater than 4, all pixels reading of the image data is performed together with execution of the stitching correction. Alternatively, it may be possible to perform reading of the image data with different thinning ratios (including a zero thinning ratio, i.e., all pixels reading) varying with the magnification of the through image. For example, if the magnification of the through image is equal to 1 through 3, thinning read operation of the image data may be performed with a thinning ratio of 4/5 (in which case no stitching correction is carried out). If the magnification of the through image is greater than 3 and smaller than 4, thinning read operation of the image data may be performed with a thinning ratio of 2/3 (in which case no stitching correction is carried out). If the magnification of the through image is equal to or greater than 4, full reading of the image data may be performed together with execution of the stitching correction. In these cases, the stitching correction may be selectively carried out solely depending on the magnification of the through image, without recourse to the thinning ratio. Moreover, the stitching correction may be performed whenever the through image is displayed on an enlarged scale.

In the first embodiment described above, the stitching correction is not performed when the image pickup sensor is operated in the thinning read mode, but the stitching correction is executed when the image pickup sensor is operated in the all pixels reading mode. Alternatively, the stitching correction may be selectively carried out depending on the thinning ratio. For example, the stitching correction may be inhibited when the thinning ratio in the thinning read mode is greater than a specified threshold value.

Furthermore, a temperature sensor 40 for detecting the temperature of the image pickup sensor may be provided and the method of reading out the image data of the image pickup sensor may be changed depending on the temperature of the image pickup sensor. For example, in case the temperature of the image pickup sensor is equal to or greater than a specified temperature, the image pickup sensor may not be allowed to operate in the all pixels reading mode if the magnification of the through image is smaller than a specified magnification (e.g., the specified magnification is 4 times magnification). In case the temperature of the image pickup sensor is less than the specified temperature, the image pickup sensor may be allowed to operate in the all pixels reading mode even when the magnification of the through image is smaller than the specified magnification (e.g., the smaller magnification is 3 times magnification). In addition, the correction amount during the stitching correction may be changed depending on the temperature of the image pickup sensor.

Furthermore, the method of reading out the image data of the image pickup sensor may be changed depending on the length of the display time of the through image. For example, in case the length of the display time of the through image is equal to or longer than a specified time period, the image pickup sensor may not be allowed to operate in the all pixels reading mode if the magnification of the through image is smaller than a specified magnification (e.g., the specified magnification is 4 times magnification). In case the length of the display time of the through image is shorter than the specified time period, the image pickup sensor may be allowed to operate in the all pixels reading mode even when the magnification of the through image is smaller than the specified magnification (e.g., the smaller magnification is 3 times magnification).

### Second Embodiment

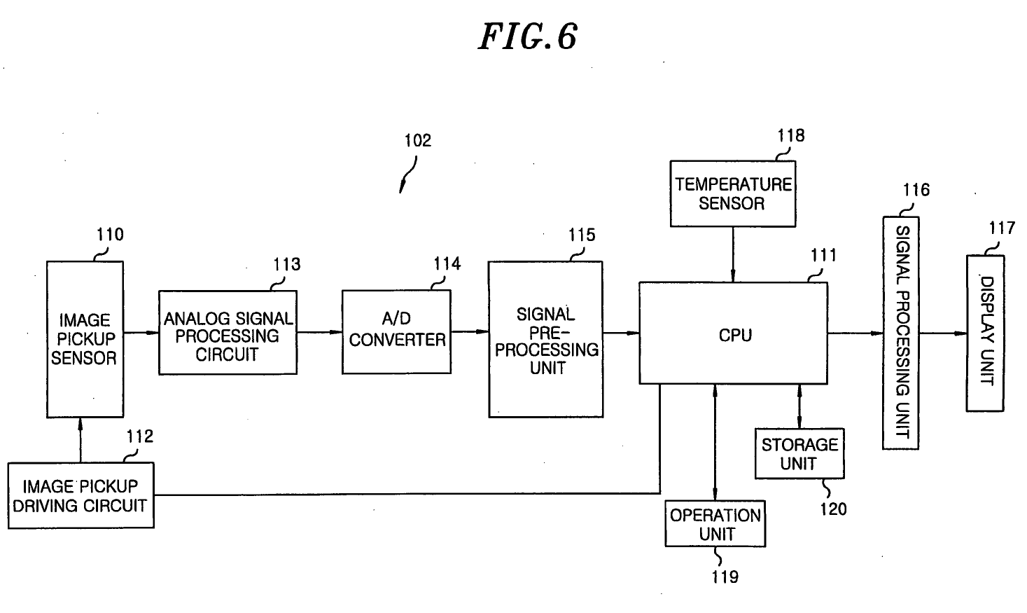

Next, an imaging device in accordance with a second embodiment of the present invention will be described with reference to the accompanying drawings which form a part hereof. FIG. 6 is a block diagram of a digital camera 102 in accordance with a second embodiment of the present invention. As shown in FIG. 6, a digital camera (imaging device) 102 includes an image pickup sensor 110 formed of a CCD, a CMOS or the like. The image pickup sensor 110 is driven by an image pickup driving circuit 112 which in turn is controlled by a CPU 111. The image pickup sensor 110 outputs image pickup signals (analog signals of accumulated charges) obtained by picking up subject light coming through a photographic lens (not shown). The image pickup sensor 110 is a 35 mm full-size image sensor (having a size of 24 mm×36 mm) and has a boundary region generated due to the use of a divided exposure process in the manufacture thereof (see FIG. 3).

The image pickup signals outputted from the image pickup sensor 110 are inputted to an A/D converter 114 through an analog signal processing circuit 113. The image pickup signals are converted to digital signals in the A/D converter 114 and then inputted to a signal pre-processing unit 115. With respect to the image data originating from the image pickup signals outputted from the A/D converter 114, the signal pre-processing unit 115 performs image processing such as white balance adjustment, contour compensation, gamma correction or the like.

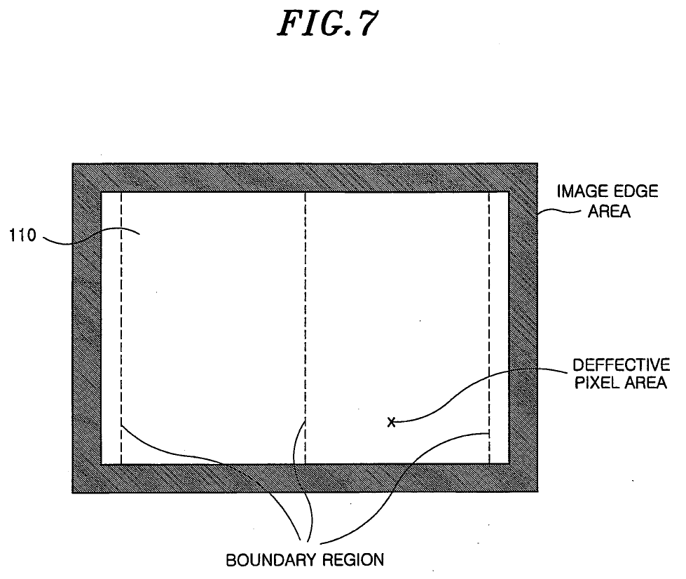

In addition, in case of displaying a through image on a below-mentioned LCD display unit 117 based on the image data, the signal pre-processing unit 115 performs correction of signal differences (or signal variations) appearing in the image data under the influence of a boundary region or the like generated due to the use of a divided exposure process in the manufacture of the image pickup sensor 110. In other words, during the manufacture of the image pickup sensor 110, the surface thereof is divided into a plurality of regions which is exposed in different exposure processes. For that reason, it is sometimes the case that there occurs a difference in the output intensity of the image pickup signals on a region-by-region basis. Therefore, the signal pre-processing unit 115 performs correction of the signal differences (or signal variations) attributable to the difference in the output intensity of the image pickup signals. Signal variations are also generated in an edge region (image edge region) and a defective pixel region of the image pickup sensor 110 as shown in FIG. 7. The signal pre-processing unit 115 also performs correction of the signal variations generated in these regions. The image data subjected to signal processing in the signal pre-processing unit 115 is inputted to a signal processing unit 116 through the CPU 111. Thinning ratio correction and other processing is performed in the signal processing unit 116, after which a through image is displayed on the LCD display unit 117.

Also connected to the CPU 111 are a temperature sensor 118 for detecting the temperature of the image pickup sensor 110 or its vicinities, an operation unit 119 provided with a power button, a selection button, a release button and the like, and a storage unit 120 that stores therein the positions of the boundary region generated due to the use of a divided exposure process in the manufacture of the image pickup sensor, the image edge region and the defective pixel region, i.e., signal variation correction regions for which correction of the signal variations is performed, the signal variation correction amounts corresponding to the respective signal variation correction regions, and so forth. It is already known through design values in which part of the image pickup sensor 110 the boundary region exists and the signal differences (or signal variations) will be generated and in which region of the edge of the image pickup sensor 110 (image edge region) the signal variations will be generated. By performing a test shooting prior to shipment, it is possible to know the amounts of the signal variations generated in different positions of the boundary region and the edge portion of the image pickup sensor 110. In advance of shipment, the position of the boundary region of the image pickup sensor 110 and the position of the image edge region are stored in the storage unit 120 as the signal variation correction regions. Also stored in the storage unit 120 are the signal variation correction amounts corresponding to the respective signal variation correction regions. Through the test shooting, it is also possible to know the position of the defective pixel region of the image pickup sensor 110 and the amount of the signal variations generated in the defective pixel region. The position of the defective pixel region of the image pickup sensor 110 and the signal variation correction amounts corresponding to the defective pixel region are stored in the storage unit 120.

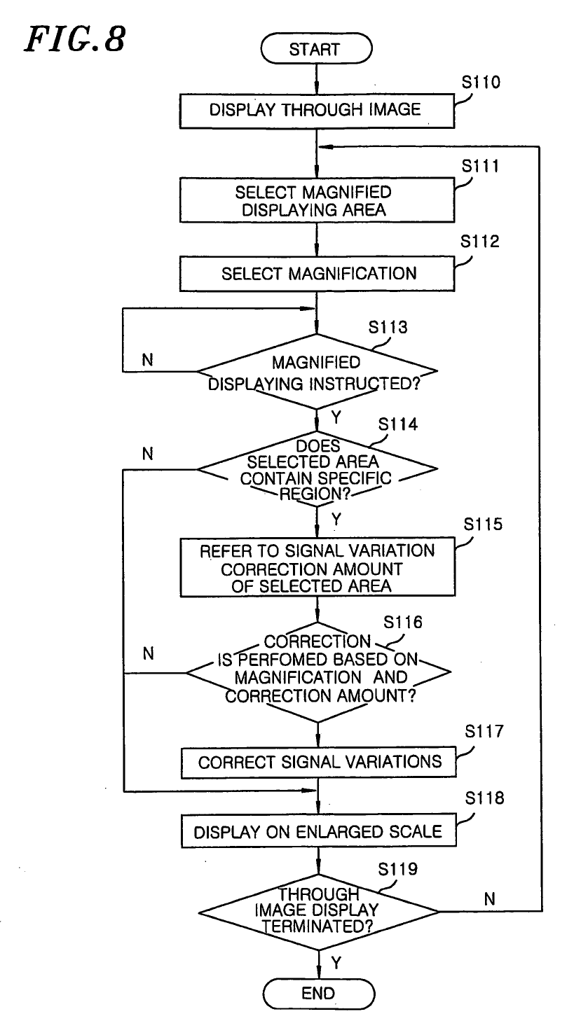

Next, an operation of the digital camera 102 in accordance with the second embodiment of the present invention will be described with reference to the flow chart illustrated in FIG. 8. First, the power button (not shown) of the operation unit 119 is operated to turn on a power supply of the digital camera 102. Then, if a through-image display mode is selected by operating the selection button (not shown) of the operation unit 119, the display of the through image on the LCD display unit 117 is started (step S110). In this regard, the magnification of the through image is set equal to 1 at the time when the power supply of the digital camera 102 is first turned on and the through-image display mode is selected. Therefore, the through image is displayed on the LCD display unit 117 using the image data (e.g., the image data with a thinning ratio of 2/3) obtained by thinning, in a specified thinning ratio, the image data originating from the image pickup signals outputted from the image pickup sensor 110.

Color filters of red (R), green (G) and blue (B) colors are arranged on individual pixels of the image pickup sensor 110 according to the Bayer color filter array. This is the same as described above with reference to FIG. 3 in the first embodiment. Therefore, no description will be offered in that regard.

In this connection, the thinning ratio is preset to, e.g., 2/3 in case the magnification of the through image is set equal to 1. Therefore, the signal processing unit 116 thins the image data corresponding to the pixels in the rows of H2, H3, H5, H6, H8, H9, H11, H12, H14 and H15 shown in FIG. 3 and the image data corresponding to the pixels in the columns of V2, V3, V5, V6, V8, V9, V11, V12, V14 and V15, thereby producing the image data with a thinning ratio of 2/3. In this case, the image data corresponding to the pixels in the columns of V8 and V9 adjacent to the boundary region of the image pickup sensor 110 are not included in the image data. For that reason, there is no need to perform the stitching correction (signal variation correction) which will be set forth later. As noted above, when producing the image data, it is possible to omit the stitching correction (signal variation correction) by thinning the image data corresponding to the pixels (pixel columns) adjacent to the boundary region.

The information regarding in which part of the image pickup sensor 110 the boundary region exists (which pixels are arranged adjacent to the boundary portion) is pre-stored in the storage unit 120. Therefore, the pixels whose signals are to be thinned are decided by using the information on the positions of the pixels adjacent to the boundary region stored in the storage unit 120. Further, by thinning the image data corresponding to the pixels of the defective pixel region are thinned with reference to the positions of the defective pixel region stored in the storage unit 120, it is possible, when producing the image data, to omit correction (stitching correction) of the signal variations generated due to the defective pixel region.

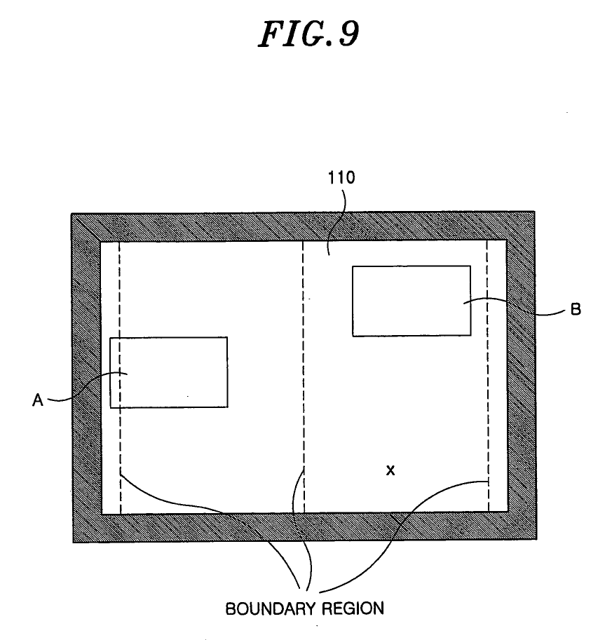

During the time when the through image is displayed on the LCD display unit 117, a magnified displaying area of the through image to be displayed on an enlarged scale is selected by operating the selection button (not shown) of the operation unit 119 (step S111), and the magnification thereof is selected (step S112). Then, when an instruction is issued to display the through image on an enlarged scale (step S113), determination is made as to whether the magnified displaying area thus selected contains a specific region (the signal variation correction region) stored in the storage unit 120 (step S114). In other words, it is determined whether the magnified displaying area thus selected contains a specific region, including the boundary region of the image pickup sensor 110, the image edge region and the defective pixel region stored in the storage unit 120. In an instance where area A shown in FIG. 9 is selected as the magnified displaying area, the flow proceeds to step S115. This is because the area A contains the specific region stored in the storage unit 120. In step S115, the signal variation correction amount stored in the storage unit 120 is referred to as a basis for the determination of correction or non-correction of the signal variations generated for the magnified displaying area thus selected.

In an instance where area B shown in FIG. 9 is selected as the magnified displaying area, the specific region stored in the storage unit 120 is not contained in the area B. Therefore, the determination made in step S114 answers “N” and the flow proceeds to step S118 where the through image is enlargedly displayed on the LCD display unit 117 with the magnification selected in step S112.

It is determined in step S116 whether or not correction of the signal variations is to be performed, based on the magnification selected in step S112 and the signal variation correction amount referred to in step S115. More specifically, in an instance where the signal variation correction amount and the magnification are all small, the signal variations have a reduced influence on the quality of the through image. Therefore, the flow proceeds to step S118 without performing correction of the signal variations. On the other hand, in an instance where the signal variation correction amount is small and the magnification is great, the signal variations have an increased influence on the quality of the through image. Therefore, the flow proceeds to step S117 where correction of the signal variations is carried out.

If it is determined in step S116 that correction of the signal variations is to be performed, such correction is carried out to prevent the signal variations, from affecting the quality of the through image (step S117). In this case, the area A contains the boundary region generated due to the use of a divided exposure process in the manufacture of the image pickup sensor 110. Therefore, it is necessary to perform correction (stitching correction) of the signal variations generated due to the presence of the boundary region.

The stitching correction performed in the second embodiment is the same as the stitching correction of the first embodiment described above with reference to FIG. 5. Therefore, no description will be offered in that regard.

In case of performing correction of the signal variations in step S117, if the area A selected as the magnified displaying area contains the image edge region where the signal variations are generated, slope correction data for use in correcting the signal variations generated in the image edge region to change in a slope pattern toward the edge of the image pickup sensor 110 are produced from the image data of a region adjacent to the image edge region. Correction of the signal variations generated in the image edge region is performed using the slope correction data. Furthermore, in case of performing correction of the signal variations in step S117, if the area A selected as the magnified displaying area contains the defective pixel region of the image pickup sensor 110, correction data for use in correcting the signal variations generated in the defective pixel region are produced from the image data of a region adjacent to the defective pixel region. Correction of the signal variations generated in the defective pixel region is performed using this correction data.

After correction of the signal variations of the image data has been performed, the corrected image data are sent to the LCD display unit 117 on which the through image is displayed on an enlarged scale (step S118). In the event that selections of a magnified displaying area to be displayed on an enlarged scale and the magnification thereof are carried out again, the flow returns back to step S111 and the processing of steps S111 to S1118 is repeated. In case the termination of display of the through image is instructed by operating the selection button (not shown) of the operation unit 119 (step S119), the supply of power to the LCD display unit 117 is stopped, thereby terminating the display of the through image.

With the imaging device of the second embodiment, in case of displaying the through image, correction of the signal variations generated in the image data due to the presence of the boundary region or the like of the image pickup sensor is selectively carried out depending on the magnified displaying area of the through image and the magnification of the through image. Thanks to this feature, it is possible to perform correction of the signal variations generated in the image data, only when such a need arises. It is also possible to prevent an increase in the load borne by the signal processing unit or the like, which would otherwise be caused by the correction of the signal variations. This helps reduce heat generation. Therefore, it becomes possible to display the through image in a good quality for an extended period of time.

In the second embodiment described above, if the temperature of the image pickup sensor 110 detected by the temperature sensor 118 exceeds a predetermined temperature and if correction of the signal variations is performed while displaying the enlarged through image on the LCD display unit 117, it may be possible to stop correction of the signal variations while continuously displaying the enlarged through image. In this case, the load borne by the signal processing unit is reduced, thereby making it possible to assure reduction of heat generation.

In the second embodiment described above, if the temperature of the image pickup sensor 110 detected by the temperature sensor 118 exceeds a predetermined temperature, it may be possible either to allow the through image to be displayed on the LCD display unit 117 on a non-enlarged scale or to stop the display of the through image. In this case, the load borne by the signal processing unit is further reduced, thereby making it possible to assure reduction of heat generation and reduction of power consumption. It may also be possible to warn beforehand that the through image will be displayed on a non-enlarged scale or the display of the through image will be stopped.

In the second embodiment described above, if the area selected as the magnified displaying area contains a specific region such as the boundary region of the image pickup sensor 110 or the like, correction of the signal variations is selectively carried out based on both the magnification selected and the signal variation correction amount for the area selected. Alternatively, it may be possible to selectively carry out correction of the signal variations based on either the magnification selected or the signal variation correction amount for the area selected.

In the second embodiment described above, the magnified displaying area of the through image and the magnification thereof may be selected using a same selection unit or different selection units.

The embodiments described hereinabove have been presented for easy understanding of the invention and are not intended to limit the invention. Accordingly, the respective elements disclosed in the foregoing embodiments shall be construed to cover all design modifications and equivalents that fall within the technical scope of the invention.

The present invention pertains to the subject matters disclosed in Japanese Patent Application Nos. 2007-198493 and 2007-270823 respectively filed on Jul. 31 and Oct. 18, 2007, the disclosures of which are apparently incorporated herein by reference in their entirety.

1. An imaging device comprising:
an image pickup sensor that images a subject to output image pickup signals, the image pickup sensor having a boundary portion generated due to a divided exposure process carried out during the manufacture thereof;
a display unit that displays a through image based on image data produced from the image pickup signals;
a selection unit that selects a magnification of the through image to be displayed on the display unit;
a correction unit that performs a correction process on signal differences generated in the image data due to the boundary portion of the image pickup sensor; and
a control unit that controls the correction unit to selectively perform the correction process based on the magnification selected by the selection unit.

2. The imaging device of claim 1, wherein the control unit allows the correction unit to perform the correction process when the magnification is equal to or greater than a threshold value.

3. The imaging device of claim 1, wherein the image pickup signals employed in generating the image data is produced by using a thinning ratio varying depending on the magnification of the through image selected by the selection unit.

4. The imaging device of claim 3, wherein the control unit prohibits the correction process of the correction unit when the thinning ratio is greater than a specified thinning ratio.

5. An imaging device comprising:
an image pickup sensor that images a subject to output image pickup signals, the image pickup sensor having a boundary portion generated due to a divided exposure process carried out during the manufacture thereof;
a display unit that displays a through image based on image data produced from the image pickup signals, which are thinned with an arbitrary thinning ratio;
a correction unit that performs a correction process on signal differences generated in the image data due to the boundary portion of the image pickup sensor; and
a control unit that controls the correction unit to selectively perform the correction process based on the thinning ratio.

6. An imaging device comprising:
an image pickup sensor that images a subject to output image pickup signals;
a display unit that displays a through image based on image data produced from the image pickup signals;
a selection unit that selects a magnified displaying area of the through image to be displayed on an enlarged scale on the display unit;
a determination unit that determines whether the magnified displaying area selected by the selection unit contains a specific region; and
a correction unit that performs a correction process on signal variations generated in the image data, if the determination unit determines that the magnified displaying area contains the specific region and if an instruction is issued to perform magnified displaying.

7. The imaging device of claim 6, further comprising:
a magnification selection unit that selects a magnification when performing the magnified displaying; and
a correction control unit that controls the correction unit to selectively perform the correction process based on the magnification selected by the magnification selection unit.

8. The imaging device of claim 7, further comprising a storage unit that stores correction amount of the signal variation of the specific region, and wherein the correction control unit controls the correction unit to selectively perform the correction process based on the correction amount of the signal variation stored in the storage unit.

9. The imaging device of claim 6, wherein the specific region comprises at least one of a boundary region generated due to the use of a divided exposure process in the manufacture of the image pickup sensor, an image edge region and a defective pixel region.

10. The imaging device of claim 1, further comprising a temperature sensor that detects a temperature of the image pickup sensor or its vicinities, and wherein the correction process in the correction unit is stopped if the temperature detected by the temperature sensor exceeds a predetermined temperature.

11. The imaging device of claim 10, wherein the through image is displayed on the display unit on a non-enlarged scale or not displayed on the display unit, if the temperature detected by the temperature sensor exceeds the predetermined temperature.

12. The imaging device of claim 2, wherein the image pickup signals employed in generating the image data is produced by using a thinning ratio varying depending on the magnification of the through image selected by the selection unit.

13. The imaging device of claim 12, wherein the control unit prohibits the correction process of the correction unit when the thinning ratio is greater than a specified thinning ratio.
